(19) United States
(12) Patent Application Publication
(10) Pub. No.: US 2005/0056212 A1
(43) Pub. Date: Mar. 17, 2005

(54) Split shroud for coating dispensing equipment

(76) Inventors: John F. Schaupp, Toledo, OH (US); David M. Seitz, Riga, MI (US); Roger T. Cedoz, Curtice, OH (US)

Correspondence Address: LISA M. SOLTIS;ILLINOIS TOOL WORKS INC., 3600 WEST LAKE AVENUE, GLENVIEW, IL, 60025, US

(21) Appl. No.: 10/822,512

(22) Filed: Apr. 12, 2004

Related U.S. Application Data
(60) Provisional application No. 60/503,118, filed on Sep. 15, 2003.

(51) Int. Cl. B05C 5/00; B05C 15/00

(52) U.S. Cl. 118/300

(57) ABSTRACT

A dispenser includes an opening through which coating material is dispensed, a coupling for coupling the opening to a source of coating material to be dispensed, and a shroud for enclosing at least a portion of the dispenser. The shroud includes two portions which engage each other at first and second joints which extend generally longitudinally of the shroud.

### FIELD OF THE INVENTION

This invention relates to dispensers for dispensing coating materials such as liquid coating materials (hereinafter sometimes “paint”) or pulverulent coating material (hereinafter sometimes “coating powder” or “powder”) suspended in a gas stream, for example, a stream of air, from, for example, a fluidized powder bed. It is disclosed in the context of a dispenser (hereinafter sometimes a “gun”) for dispensing coating powder. However, it is believed to have utility in other applications as well.

### BACKGROUND OF THE INVENTION

Systems for dispensing coating materials are known. There are, for example, the systems illustrated and described in U.S. Pat. Nos. 3,536,514; 3,575,344; 3,698,636; 3,843,054; 3,913,523; 3,964,683; 4,037,561; 4,039,145; 4,114,564; 4,135,667; 4,169,560; 4,216,915; 4,360,155; 4,381,079; 4,447,008; 4,450,785; Re. 31,867; 4,520,754; 4,580,727; 4,598,870; 4,685,620; 4,788,933; 4,798,340; 4,802,625; 4,825,807; 4,921,172; 5,353,995; 5,358,182; 5,433,387; 5,720,436; 5,853,126; and, 6,328,224. There are also the devices illustrated and described in U.S. Pat. Nos. 2,759,763; 2,955,565; 3,102,062; 3,233,655; 3,578,997; 3,589,607; 3,610,528; 3,684,174; 4,066,041; 4,171,100; 4,214,708; 4,215,818; 4,323,197; 4,350,304; 4,402,991; 4,422,577; Re. 31,590; 4,505,430; 4,518,119; 4,726,521; 4,779,805; 4,785,995; 4,879,137; 4,890,190; and, 4,896,384; British Patent Specification 1,209,653; Japanese published patent applications: 62-140,660; 1-315,361; 3-169,361; 3-221,166; 60-151,554; 60-94,166; 63-116,776; 58-124,560; and 331,823 of 1972; and, French patent 1,274,814. There are also the devices illustrated and described in “Aerobell™ Powder Applicator ITW Automatic Division” and “Aerobell™ & Aerobell Plus™ Rotary Atomizer, DeVilbiss Ransburg Industrial Liquid Systems.” The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

### DISCLOSURE OF THE INVENTION

According to an aspect of the invention, a dispenser includes an opening through which coating material is dispensed, a coupling for coupling the opening to a source of coating material to be dispensed, and a shroud for enclosing at least a portion of the dispenser. The shroud includes two portions which engage each other at first and second joints which extend generally longitudinally of the shroud.

Illustratively, the shroud comprises a somewhat right cylindrical shroud

Further illustratively, the shroud comprises a somewhat right circular cylindrical shroud, and each of the two portions is consequently part right circular cylindrical.

Illustratively, the shroud includes a longitudinal axis. A first one of the portions subtends an arc measured about the axis of somewhat more than 180°, and a second one of the portions subtends an arc about the axis of somewhat less than 180°. Further illustratively according to this aspect, the first one of the portions subtends an arc measured about the axis of about 200°, and the second one of the portions subtends an arc measured about the axis of about 160°.

Illustratively, the shroud portions are constructed from resilient, electrically non-conductive materials. Further illustratively according to this aspect, the shroud portions are constructed from acetal resin.

Illustratively, the shroud portions include inner sidewalls including grooves which extend generally longitudinally therealong.

Illustratively, a first of the shroud portions includes a lateral edge including a first feature, and a second of the shroud portions includes a lateral edge including a second feature which is complementary to the first feature.

Further illustratively according to this aspect, the first feature comprises a somewhat V-bottomed groove, and the second feature comprises a somewhat V-shaped edge.

Additionally illustratively according to this aspect, the first shroud portion includes two lateral edges. Each lateral edge of the first shroud portion includes a first feature. The second shroud portion includes two lateral edges. Each lateral edge of the second shroud portion includes a second feature which is complementary to the first feature. Each first feature comprises a somewhat V-bottomed groove. Each second feature comprises a somewhat V-shaped edge.

Further illustratively according to this aspect, the apparatus includes a gasket material interposed between the first and second features.

Illustratively, the dispenser includes a forward end adjacent the opening. The forward end includes a feature for cooperating with a feature provided on a forward end of a first one of the shroud portions to facilitate engagement of the forward end of the first one of the shroud portions with the forward end of the dispenser. The forward end also includes a feature for cooperating with a feature provided on a forward end of a second one of the shroud portions to facilitate engagement of the forward end of the second one of the shroud portions with the forward end of the dispenser.

Illustratively, the feature on the forward end of one of the dispenser and the shroud portions comprises a groove extending substantially continuously around a perimeter of the forward end of said one of the dispenser and the shroud portions, and the feature provided on the forward end of the other of the dispenser and the shroud portions includes a lip for engaging the groove.

Illustratively, the dispenser includes a rearward end including a feature for cooperating with a feature provided on a rearward end of a first one of the shroud portions to facilitate engagement of the rearward end of the first one of the shroud portions with the rearward end of the dispenser. The rearward end of the dispenser also includes a feature for cooperating with a feature provided on a rearward end of a second one of the shroud portions to facilitate engagement of the rearward end of the second one of the shroud portions with the rearward end of the dispenser.

Illustratively according to this aspect, the feature on a rearward end of the dispenser includes a ring including at least one tab, and the feature provided on a rearward end of a first one of the shroud portions includes a flange provided with at least one passageway permitting passage of the at least one tab therethrough during assembly of the shroud to the dispensing device.

Illustratively according to this aspect, the dispenser includes a forward end adjacent the opening. The forward end includes a feature for cooperating with a feature provided on a forward end of a first one of the shroud portions to facilitate engagement of the forward end of the first one of the shroud portions with the forward end of the dispenser. The forward end of the dispenser also includes a feature for cooperating with a feature provided on a forward end of a second one of the shroud portions to facilitate engagement of the forward end of the second one of the shroud portions with the forward end of the dispenser.

Illustratively according to this aspect, the feature provided on a rearward end of a first one of the shroud portions includes a ramp surface provided on the flange for cooperating with the at least one tab to urge the feature provided on a forward end of the first one of the shroud portions into engagement with the forward end of the dispenser.

Illustratively, the source of coating material to be dispensed comprises a source of pulverulent coating material suspended in a gas or mixture of gases.

### BRIEF DESCRIPTION OF THE DRAWINGS

The invention may best be understood by referring to the following detailed description and accompanying drawings which illustrate the invention. In the drawings:

FIG. 1 illustrates a system constructed according to an aspect of the invention, with certain components of the system illustrated in fragmentary longitudinal sectional side elevational view, and other components of the system illustrated diagrammatically;

FIG. 2 illustrates a front elevational view of a detail of the system illustrated in FIG. 1;

FIG. 3 illustrates a side elevational view of the detail illustrated in FIG. 2;

FIG. 4 illustrates a rear elevational view of the detail illustrated in FIGS. 2-3;

FIG. 5 illustrates a sectional view of the detail illustrated in FIGS. 2-4, taken generally along section lines 5-5 of FIG. 4;

FIG. 6 illustrates a sectional view of the detail illustrated in FIGS. 2-5, taken generally along section lines 6-6 of FIG. 4;

FIG. 7 illustrates a sectional view of the detail illustrated in FIGS. 2-6, taken generally along section lines 7-7 of FIG. 4;

FIG. 8 illustrates a front elevational view of a detail of the system illustrated in FIG. 1;

FIG. 9 illustrates a sectional view of the detail illustrated in FIG. 8, taken generally along section lines 9-9 of FIG. 8;

FIG. 10 illustrates a front elevational view of a detail of the system illustrated in FIG. 1;

FIG. 11 illustrates a side elevational view of the detail illustrated in FIG. 10;

FIG. 12 illustrates a rear elevational view of the detail illustrated in FIGS. 10-11;

FIG. 13 illustrates a sectional view of the detail illustrated in FIGS. 10-12, taken generally along section lines 13-13 of FIG. 12;

FIG. 14 illustrates a sectional view of the detail illustrated in FIGS. 10-13, taken generally along section lines 14-14 of FIG. 12;

FIG. 15 illustrates a side elevational view of a detail of the system illustrated in FIG. 1;

FIG. 16 illustrates a rear elevational view of the detail illustrated in FIG. 15;

FIG. 17 illustrates a side elevational view of a detail of the system illustrated in FIG. 1;

FIG. 18 illustrates a rear elevational view of the detail illustrated in FIG. 17;

FIG. 19 illustrates a longitudinal sectional side elevational view of the detail illustrated in FIGS. 17-17;

FIG. 20 illustrates a longitudinal sectional side elevational view of a detail of the system illustrated in FIG. 1;

FIG. 21 illustrates a rear elevational view of a detail of the system illustrated in FIG. 1;

FIG. 22 illustrates a longitudinal sectional side elevational view of the detail illustrated in FIG. 21;

FIG. 23 illustrates a rear elevational view of a detail of the system illustrated in FIG. 1;

FIG. 24 illustrates a side elevational view of the detail illustrated in FIG. 23;

FIG. 25 illustrates a front elevational view of a detail of the system illustrated in FIG. 1;

FIG. 26 illustrates a longitudinal sectional side elevational view of the detail illustrated in FIG. 25; and,

FIG. 27 illustrates a fragmentary sectional view of the detail illustrated in FIGS. 21-22 and the detail illustrated in FIGS. 23-24, taken generally along section lines 27-27 of FIG. 21 and FIG. 23.

### DETAILED DESCRIPTIONS OF ILLUSTRATIVE EMBODIMENTS

As used in this application, terms such as “electrically conductive” and “electrically non-insulative” refer to a broad range of conductivities electrically more conductive than materials described as “electrically non-conductive” and “electrically insulative.” Terms such as “electrically semiconductive” refer to a broad range of conductivities between electrically conductive and electrically non-conductive. Terms such as “front,” “back,” “up,” “down,” and the like, are used only to describe an illustrative embodiment, and are not intended as limiting.

Coating material particles are typically quite small. Sizes in the range of 5 μm-50 μm are not uncommon. As a result, coating material particles are typically highly penetrating, that is, capable of entering through small openings into, for example, equipment used to dispense them and accumulating there. As a consequence, it is desirable to design coating material dispensing equipment with a view toward being able to clean it without too much difficulty.

In order to clean powder coating equipment between an interval during which a first color or type of powder coating material is being dispensed and an interval during which a second color or type of powder coating material is being dispensed, cleaning of the powder coating equipment is conducted at intervals. Such cleaning may involve, for example, wiping down of the equipment to dislodge any accumulated powder.

Additionally, coating material dispensing equipment needs to be designed with a view toward conducting other types of maintenance, routine and otherwise, on the equipment. Maintenance sometimes involves disassembly of covers, or shrouds, which enclose components of the coating material dispensing system, for example, to reduce the exposure of such components to dispensed coating material. Covering of such components has the potential to reduce the amount and complexity of the cleaning which must be conducted on the dispensing equipment. Consequently, a consideration in the design of such shrouds is the ability of the shrouds to protect covered components against the ingress of coating material into the covered components, while at the same time facilitating the removal of the shrouds so that covered components can be serviced as necessary.

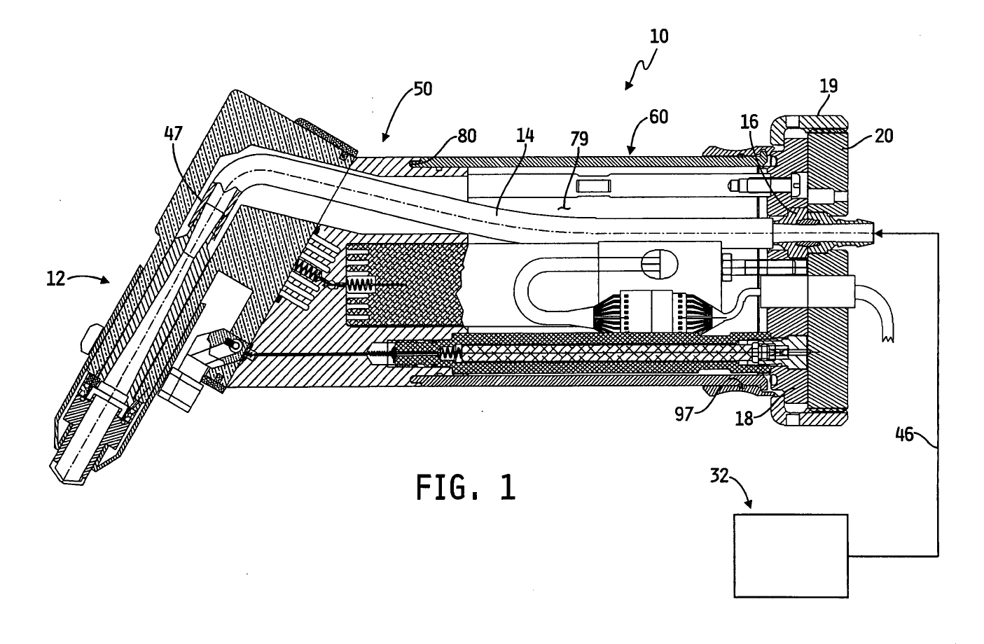

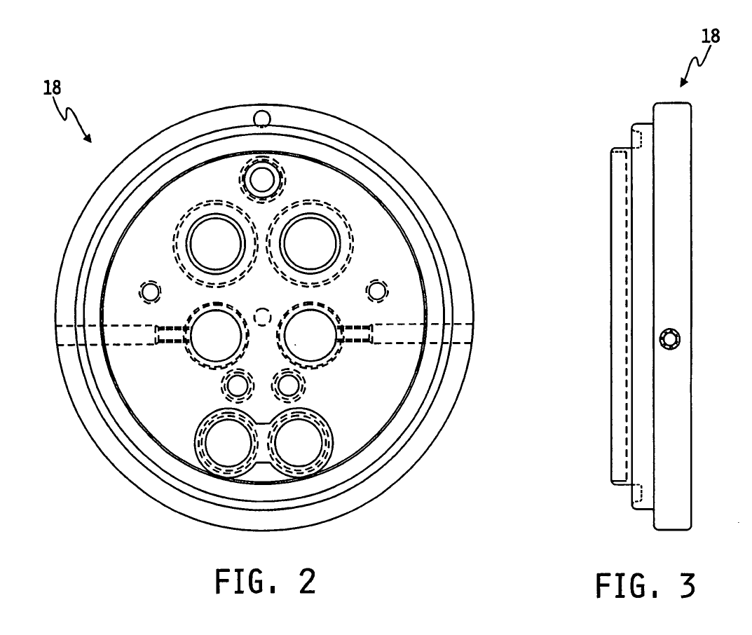

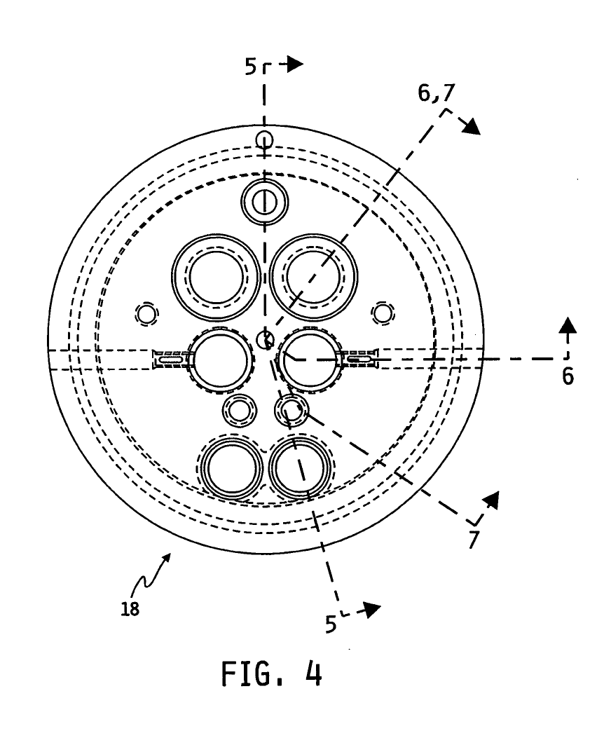

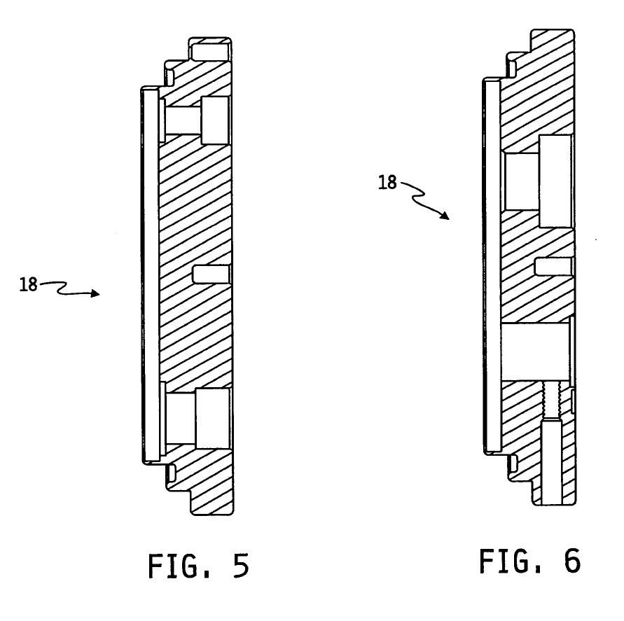

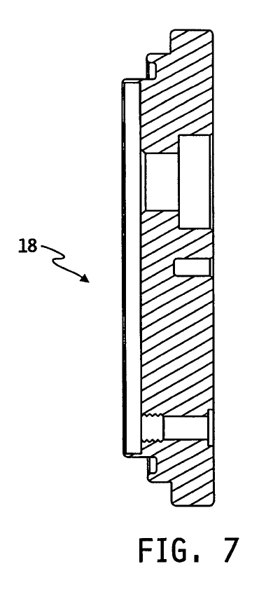

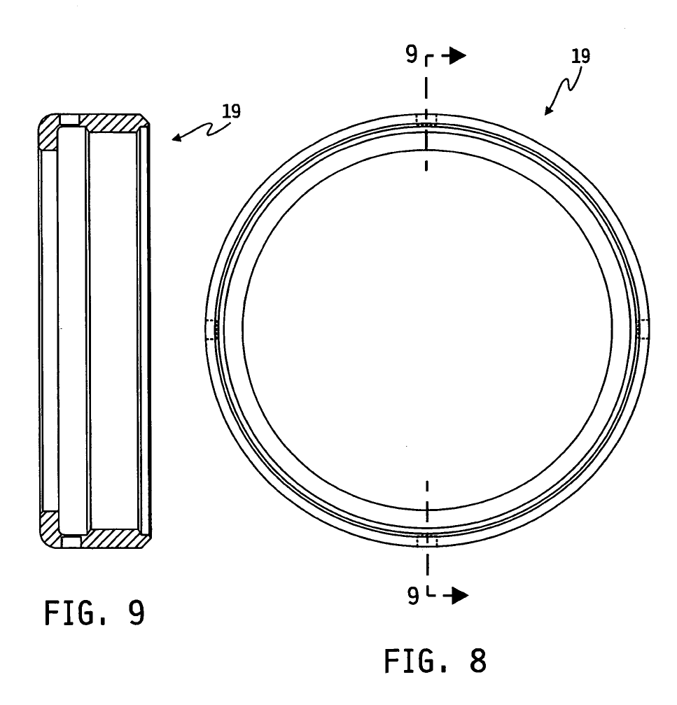

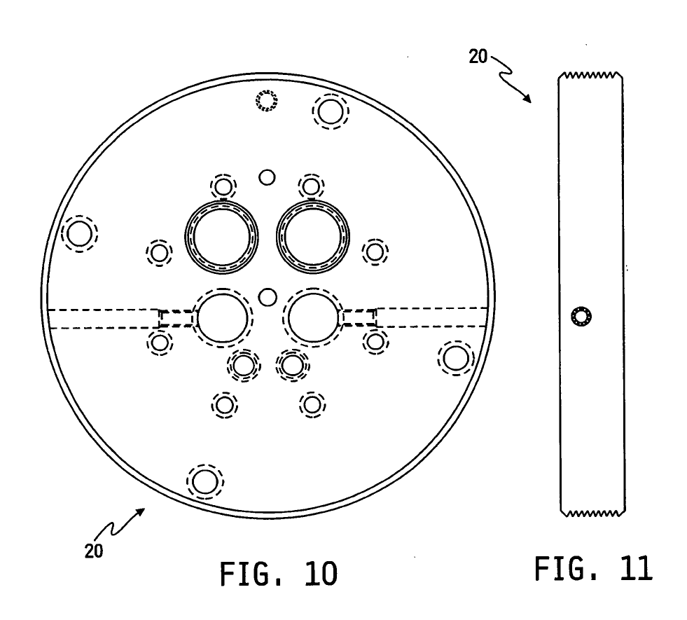

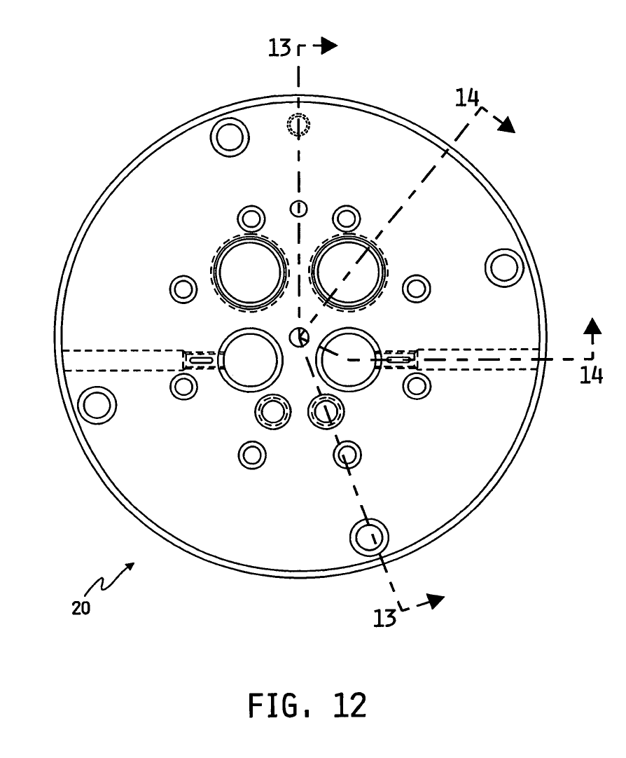

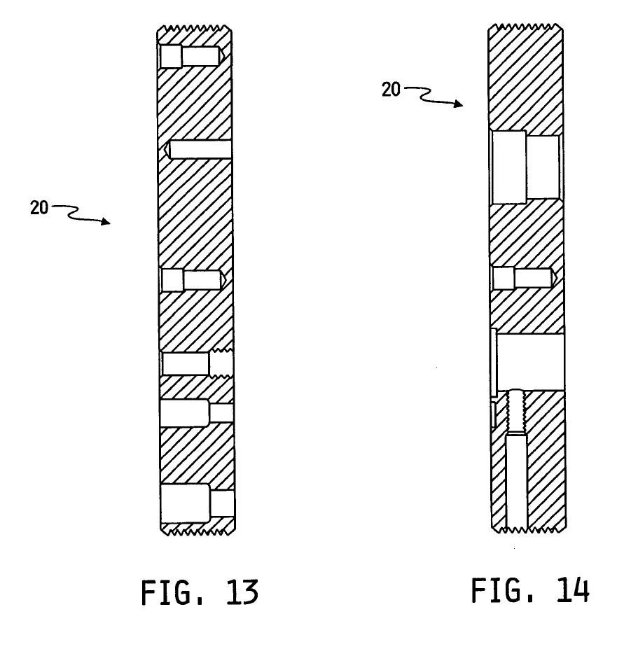

FIG. 1 illustrates a powder gun 10 of the general type of, for example, an RPG-2 dual head robot powder gun model 78772 available from ITW GEMA Automotive Systems, ITW Automotive Finishing Group, 48152 West Road, Wixom, Mich. 48393. Gun 10 includes two side-by-side nozzles 12, only one of which is illustrated. Each nozzle 12 is coupled through a respective powder delivery tube 14 to a respective inside-the-gun 10 powder hose barbed fitting 16 mounted in a passageway provided therefor in a robot powder gun rear plate 18 (also see FIGS. 2-7). Robot powder gun rear plate 18 is coupled by a threaded robot plate retaining ring 19 (see also FIGS. 8-9) to a robot powder gun adapter plate 20 (see also FIGS. 10-14). Each of plates 18, 20 includes mating passageways for the various services with which the gun 10 is provided. Such services for electrostatically aided liquid and powder coating guns include, for example, conductors for low- and/or high-magnitude electrical potential, coating material supplies, such as, for example, air entrained powder supplies, compressed gas, for example, air, and so on.

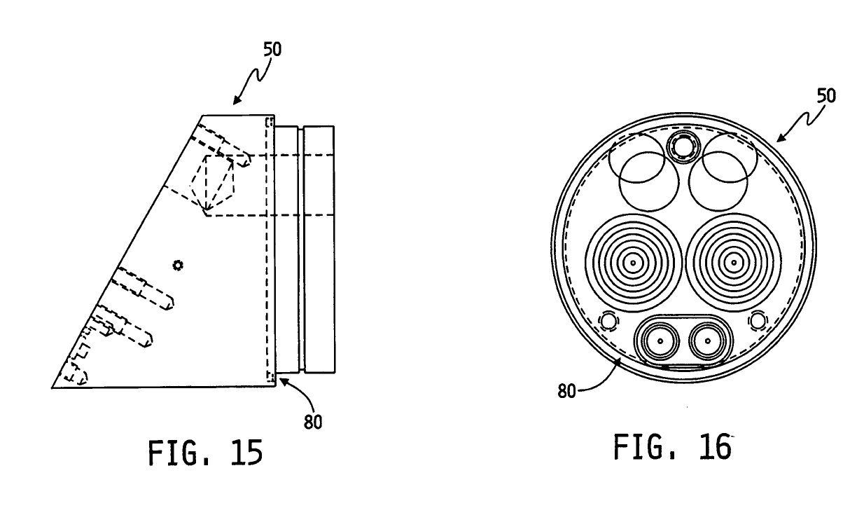

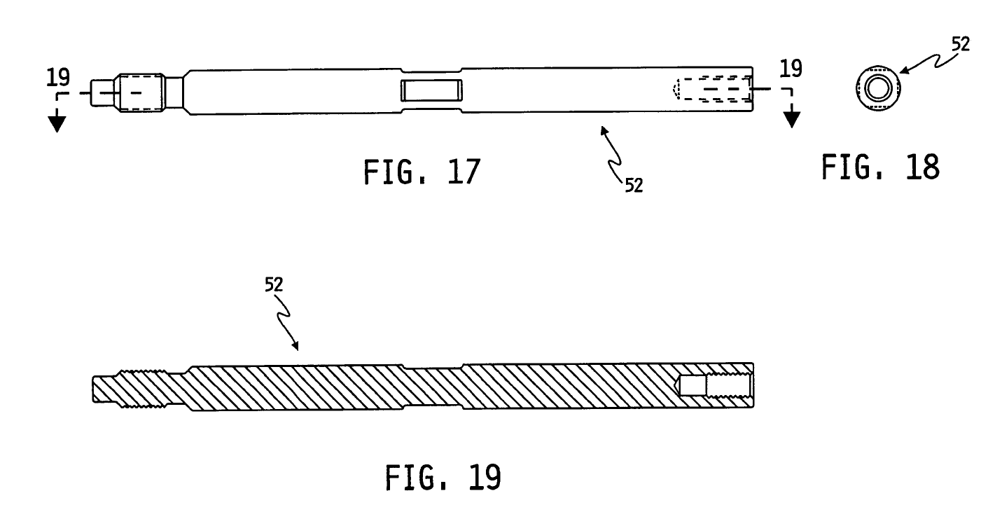

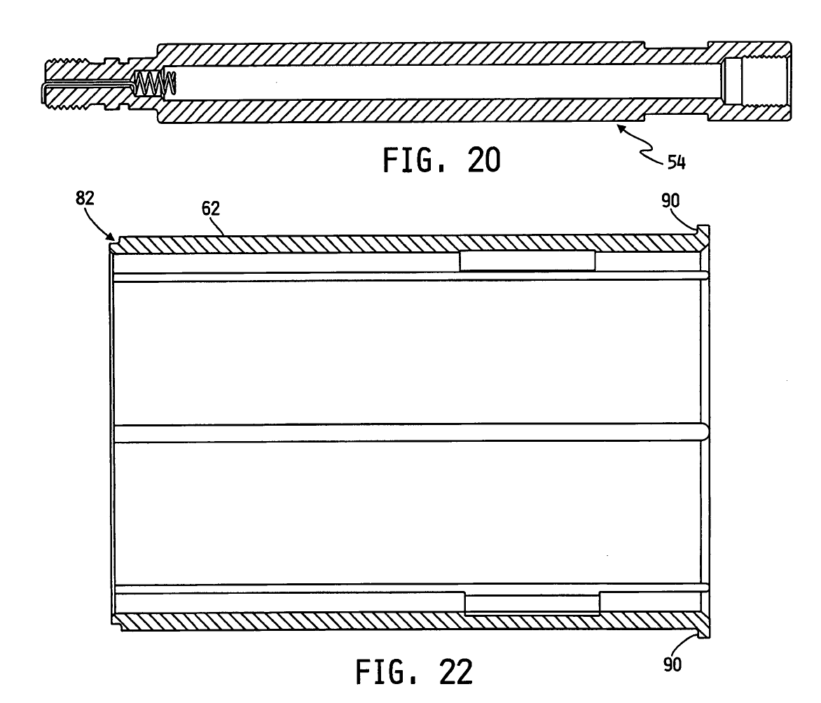

Powder flows from a powder source 32 forward through powder delivery tube 14 to nozzle 12. Powder source 32 may be of any of a number of known types such as, for example, a fluidized bed of the general type illustrated and described in U.S. Pat. No. 5,768,800. A powder supply hose 46 extends from powder source 32 through a robot arm (not shown) to the end of which robot powder gun adapter plate 20 is mounted. A proximal end 47 of powder delivery tube 14 is coupled through a forward manifold 50 (see also FIGS. 15-16) to the nozzles 12 mounted on manifold 50. Powder delivery tube 14 and other gun 10 components are housed between manifold 50 and the robot powder gun rear plate 18. The forward manifold 50 is supported from the rear plate 18 by a number, illustratively two, of support posts 52 (see also FIGS. 17-19), 54 (see also FIG. 20) which include appropriate fastening means, such as threaded lugs and threaded holes, to facilitate attachment to rear plate 18 and manifold 50. Support posts 52, 54 may also include (a) cavity(ies), illustrated in post 54, for housing (a) resistor(s) for coupling between (a) corona ring(s) surrounding nozzles 12 and, for example, a reference potential, such as ground.

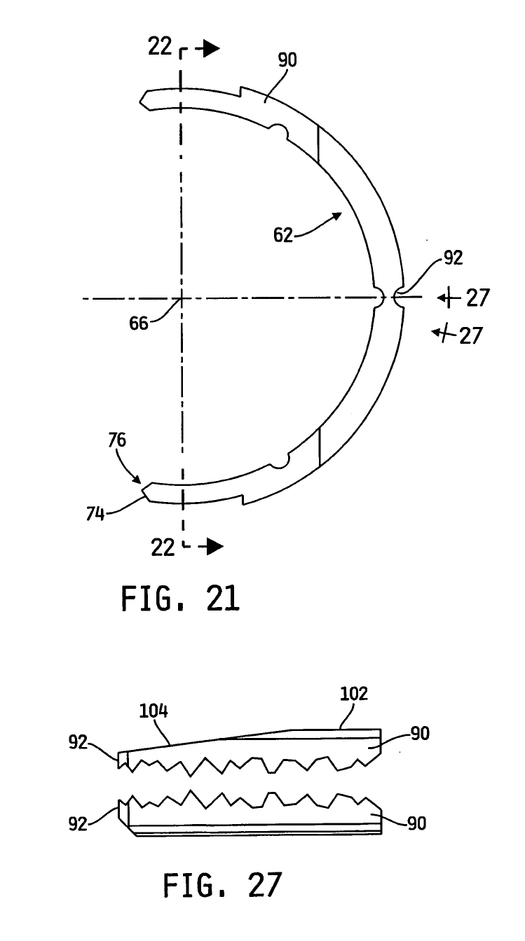

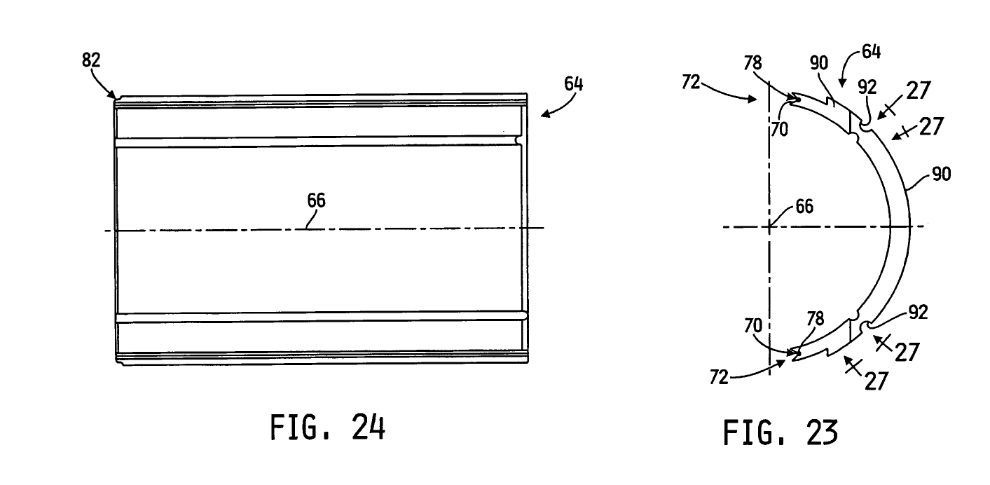

An illustratively somewhat right circular cylindrical shroud 60, surrounds and encloses portions of such powder dispensing equipment, connections 14 and the like. The shroud 60 includes two portions 62 (see also FIGS. 21, 22 and 27), 64 (see also FIGS. 23, 24 and 27), which are sometimes referred to hereinafter as a larger portion 62 and a smaller portion 64. Each of the portions 62, 64 is part right circular cylindrical. The larger portion 62 subtends an arc measured about an axis 66 of the cylinder 60, of somewhat more than 180°, for example, 200°, while the smaller portion 64 subtends an arc about axis 66, of somewhat less than 180°, for example, 160°. Shroud portions 62, 64 are illustratively constructed from electrically non-conductive materials which are flexible. An illustrative material includes white Acetron GP acetal resin. This flexibility enables components 62, 64 to be snapped over gun 10 components housed within the shroud 60 during assembly and disassembly. Grooves may be provided in the inner sidewalls of shroud portions 62, 64 to enhance flexibility. Additional features may be provided on the inner sidewalls of shroud portions 62, 64, for example, to facilitate assembly and disassembly of gun 10 components, to provide clearance between gun 10 components and shroud portions 62, 64, and so on.

A first of the portions, illustratively, the smaller portion 64, is provided with a feature 70, for example, a somewhat V-bottomed groove, along each of its lateral edges 72. The second of the portions, illustratively, the larger portion 62, is provided with complementary feature 74, illustratively a somewhat V-shaped edge, along each of its lateral edges 76 to cooperate with respective ones of the somewhat V-bottomed grooves 70 along respective lateral edges 72 of the first portion 64. One or the other or both of features 70, 74 can be furnished with, for example, gasket material 78, such as, for example, O-ring material, to promote sealing of portions 62, 64 together to impede the penetration of dispensed coating material into the interior 79 of shroud 60.

Forward manifold 50 includes a perimetrally extending, rearwardly facing feature 80, such as a groove or relief for cooperating with complementary forward features 82, illustratively lips, of larger shroud portion 62 and smaller shroud portion 64.

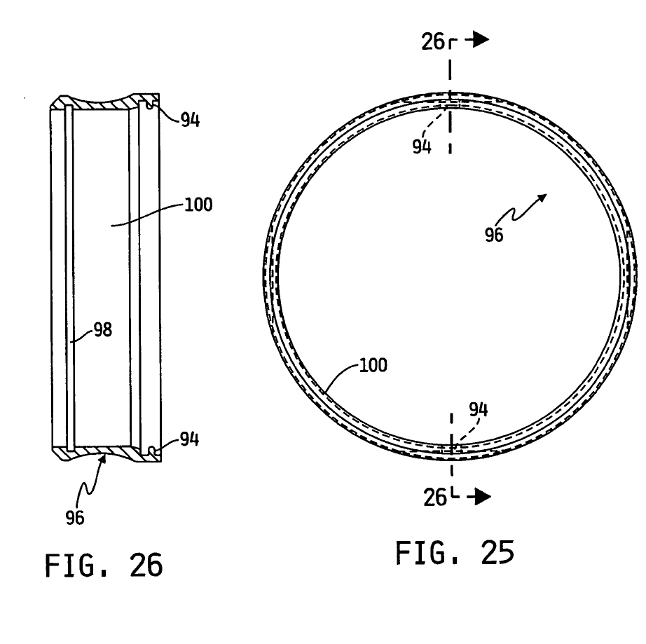

At its rearward end, each shroud portion 62, 64 includes a flange 90 which extends perimetrally partway around its rearward extent. Flanges 90 are interrupted at intervals by passageways 92 which permit the passage of respective tabs 94 of a shroud retainer ring 96 (see also FIGS. 25-26). The interior of shroud retainer ring 96 is sized to receive in a sliding, sealing orientation the assembled shroud components 62, 64. To this end, a sealing O-ring 97 may be accommodated in a groove 98 provided therefor around the interior 100 of shroud retainer ring 96. The rearwardly facing side 102 of each flange 90 adjacent each passageway 92 is bevelled as illustrated at 104. The bevel 104 promotes entry of the finger 94 that projects through that respective passageway 92 during assembly of the shroud 60 onto gun 10 into the space between robot powder gun rear plate 18 and the flange 90 to urge features 80, 82 into sealing engagement.

1. A dispenser including an opening through which coating material is dispensed, a coupling for coupling the opening to a source of coating material to be dispensed, and a shroud for enclosing at least a portion of the dispenser, the shroud including two portions which abut each other at first and second joints which extend generally longitudinally of the shroud.

2. The apparatus of claim 1 wherein the shroud comprises a somewhat right cylindrical shroud.

3. The apparatus of claim 2 wherein the shroud comprises a somewhat right circular cylindrical shroud.

4. The apparatus of claim 3 wherein each of the two portions is part right circular cylindrical.

5. The apparatus of claim 1 wherein the shroud includes a longitudinal axis, a first one of the portions subtends an arc measured about the axis of somewhat more than 180°, and a second one of the portions subtends an arc about the axis of somewhat less than 180°.

6. The apparatus of claim 5 wherein the first one of the portions subtends an arc measured about the axis of about 200°, and the second one of the portions subtends an arc measured about the axis of about 160°.

7. The apparatus of claim 1 wherein the shroud portions are constructed from resilient, electrically non-conductive materials.

8. The apparatus of claim 7 wherein the shroud portions are constructed from acetal resin.

9. The apparatus of claim 7 wherein the shroud portions include inner sidewalls including grooves which extend generally longitudinally therealong.

10. The apparatus of claim 1 wherein a first of the shroud portions includes a lateral edge including a first feature, and a second of the shroud portions includes a lateral edge including a second feature which is complementary to the first feature.

11. The apparatus of claim 10 wherein the first feature comprises a somewhat V-bottomed groove, and the second feature comprises a somewhat V-shaped edge.

12. The apparatus of claim 11 wherein the first shroud portion includes two lateral edges, each including a first feature, the second shroud portion includes two lateral edges, each including a second feature which is complementary to the first feature, each first feature comprising a somewhat V-bottomed groove, and each second feature comprising a somewhat V-shaped edge.

13. The apparatus of claim 10 further including a gasket material interposed between the first and second features.

14. The apparatus of claim 1 wherein the source of coating material to be dispensed comprises a source of pulverulent coating material suspended in a gas or mixture of gases.

15. The apparatus of claim 1 wherein the dispenser includes a forward end adjacent the opening, the forward end including a feature for cooperating with a feature provided on a forward end of a first one of the shroud portions to facilitate engagement of the forward end of the first one of the shroud portions with the forward end of the dispenser, and a feature for cooperating with a feature provided on a forward end of a second one of the shroud portions to facilitate engagement of the forward end of the second one of the shroud portions with the forward end of the dispenser.

16. The apparatus of claim 15 wherein the feature on the forward end of one of the dispenser and the first one of the shroud portions comprises a groove extending substantially continuously around a perimeter of the forward end of said one of the dispenser and the first one of the shroud portions, and the feature provided on the forward end of the other of the dispenser and the first one of the shroud portions includes a lip for engaging the groove.

17. The apparatus of claim 1 wherein the dispenser includes a rearward end including a feature for cooperating with a feature provided on a rearward end of a first one of the shroud portions to facilitate engagement of the rearward end of the first one of the shroud portions with the rearward end of the dispenser, and a feature for cooperating with a feature provided on a rearward end of a second one of the shroud portions to facilitate engagement of the rearward end of the second one of the shroud portions with the rearward end of the dispenser.

18. The apparatus of claim 17 wherein the feature on a rearward end of the dispenser includes a ring including at least one tab, and the feature provided on a rearward end of a first one of the shroud portions includes a flange provided with at least one passageway permitting passage of the at least one tab therethrough during assembly of the shroud to the dispensing device.

19. The apparatus of claim 18 wherein the dispenser includes a forward end adjacent the opening, the forward end including a feature for cooperating with a feature provided on a forward end of a first one of the shroud portions to facilitate engagement of the forward end of the first one of the shroud portions with the forward end of the dispenser, and a feature for cooperating with a feature provided on a forward end of a second one of the shroud portions to facilitate engagement of the forward end of the second one of the shroud portions with the forward end of the dispenser.

20. The apparatus of claim 19 wherein the feature provided on a rearward end of a first one of the shroud portions includes a ramp surface provided on the flange for cooperating with the at least one tab to urge the feature provided on a forward end of the first one of the shroud portions into engagement with the forward end of the dispenser.
